(19) United States
(12) Patent Application Publication
(10) Pub. No.: US 2023/0043509 A1
(43) Pub. Date: Feb. 9, 2023

(54) Application Programming Interface-Enabled Check Generation Service

(71) Applicant: Bank of America Corporation, Charlotte, NC (US)

(72) Inventors: Morgan S. Allen, Waxhaw, NC (US); Monika Kapur, Jacksonville, FL (US); Gilbert M. Gatchalian, Union, NJ (US)

(21) Appl. No.: 17/392,503

(22) Filed: Aug. 3, 2021

(51) Int. Cl. G06Q 40/02; G06Q 20/10; G06Q 20/04; G06Q 10/08; G06F 3/0484; G06K 9/22

(52) U.S. Cl. CPC G06Q 40/02; G06Q 20/108; G06Q 20/0425; G06Q 10/083; G06F 3/0484; G06K 9/228; G06Q 20/40145

(57) ABSTRACT

Various aspects of the disclosure relate to automated generation and electronic delivery of digital representations of guaranteed financial instruments. A check generation service platform may process personal financial instrument images, along with user account information, to generate electronic representations of guaranteed financial products. Delivery of the guaranteed financial product may be performed as an electronic message comprising one or more of a bar code, a QR code, or an electronic token, and an electronic image that may be executed by a third-party computing platform.

### BACKGROUND

Online banking and mobile banking have provided customers of a bank with the ability to bank at their convenience and perform a variety of transactions without having to visit branch locations of a bank. Some transactions still require a visit to a branch location where the customer may have to spend some time waiting for a bank associate's assistance and/or for a bank associate to process the transaction.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure provide solutions that address and overcome technical problems associated with automatically generating bank checks through an automated certified check generation interface and which may be associated with in person transactions, online transactions, and/or other operations. In particular, one or more aspects of the disclosure relate to use of application programming interfaces (APIs) for communicating with applications to automatically generate or otherwise provide electronic or physical certified checks.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes converting a personal financial instrument, such as a personal check, into a certified financial instrument, such as a certified check.

A user may provide a physical personal check to a merchant or service provider to initiate a transaction for goods or services. In some cases, the merchant or service provider may not accept a personal check to complete the transaction. As such, a need has been recognized to for a system and/or method to convert a personal check to a guaranteed financial instrument, such as a certified check an issue the guaranteed financial instrument as an electronic financial instrument, a physical financial instrument, or both an electronic financial instrument and a physical financial instrument. A personal financial instrument (e.g., a personal check) may be used, at least in part, to initiate a conversion process by an enterprise computing system that may generate a bar code, QR code, an electronic token, or a certified check. In some cases, the bar code, QR code, and/or electronic token may be used as a verified certification that the personal check may be considered a certified check with payment guaranteed by the enterprise organization. In some cases, scanning the bar code or QR code, or processing of the electronic token, may automatically cause completion of an electronic transaction such as by causing an electronic transfer of funds from an account associated with the enterprise organization to an account associated with the merchant or vendor. In some cases, an image of a certified check or other certified financial product, may be communicated to the merchant or service provider to complete the sale or initiate the service upon printing or depositing a printed version of the image. In some cases, an electronic token may be used to authenticate the personal check as a certified check for the merchant or service provider's electronic transaction records.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment providing automatic generation of certified checks, in accordance with one or more aspects described herein;

FIG. 1B shows an illustrative computing platform enabled for automated generation of certified checks, in accordance with one or more aspects described herein; and

FIGS. 2 and 3 show illustrative event sequences for automatic generation of certified checks, in accordance with one or more example arrangements.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

Enterprise organizations, such as financial institutions, have increasingly been providing computing functionality online as products or services. Increasingly financial institutions have been providing electronic services or processes (e.g., an application programming interface (API), banking as a service functionality, and the like) where the licensed financial organizations (e.g., banks, brokerages, and the like) may integrate their digital services directly into the products of other non-financial service-licensed businesses. APIs may be used by in-house applications and/or third-party applications and/or web interfaces to interact with computing functions provided by an enterprise organization. In this way, contracting businesses, such as a car dealer, an airline and the like, can offer customers digital services such as mobile bank accounts, debit cards, loans and payment services, without needing to acquire a banking license of their own. The financial institution may a provide application programming interface (API), webhooks, and/or the like where a third-party may be leverage the API interface to allow their customers to access online products and/or services, normally offered through financial institutions, directly from the third-party website or application.

In an illustrative example, consider a case where an individual desires to purchase a vehicle, or make another large purchase, with cash, and a merchant, vendor, or seller may require payment in a form that is guaranteed by a financial institution, such as in the form of a certified check. In cases where a bank or other financial institution was closed or otherwise unavailable (e.g., offline, or the like) or in cases where traveling to the bank of financial institution is inconvenient or impossible, another form of payment guarantee may be desirable. In some cases, the application programming interface-enabled check generation service may provide systems and methods for a user to provide a financial institution guaranteed payment in a form of an automatically generated and/or electronically generated financial product, where the financial institution guarantees a payment to confirm a purchase where funds for the financial product have been escrowed or otherwise set aside. In some cases, the application programming interface-enabled check generation service may provide a user interface capable of scanning a physical payment method (e.g., a personal check) and converting the physical payment method into a guaranteed digital asset that may be virtually relayed to a merchant as a certified or official payment method for the purchased product.

Personal checks may be used by individuals as an indication of an intent to render payment for goods and/or services and represent a guarantee of payment through personal funds. In many cases, a form of payment guaranteed with funds associated with a financial institution may be deemed to be a more reliable form of payment by a merchant or service provider. In situations, where the individual is unable to appear in person at a financial institution and/or where the financial institution is unable to provide a physical representation of a guaranteed payment, such as a certified check, an application or web service may be capable of providing a guaranteed electronic payment to enable a transaction to occur. In some cases, personal check or the like may be converted into a guaranteed form of payment through a process initiated by the user communicating, via a communications network, an intention to convert the personal check, electronic or physical, into a guaranteed financial institution provided payment method against funds electronically available in the user's account. The financial institution may electronically hold the funds in escrow until the associated transaction completes. The financial institution may communicate an electronic validation or other indication of a guaranteed electronic payment has been approved, such as by communicating a bar code, a quick response (QR) code, an electronic token and/or the like. In some cases, a communication may be communicated to the merchant of the service provider, proof that a physical financial instrument, such as a bank check, may be communicated via a parcel delivery service. Once the electronic transaction, or the electronic portion of the transaction, is complete, a communication may be sent to the user and/or the merchant or service provider a physical validation, such as a physical copy of a financial instrument, such as a certified check.

In an illustrative example, a user may provide a physical personal check to a merchant or service provider to initiate a transaction for goods or services, such as a vehicle purchase, a real estate purchase and/or the like. In some cases, the merchant or service provider may not accept a personal check to complete the transaction. As such, a need has been recognized to for a system and/or method to convert a personal check to a guaranteed financial product, such as a certified check an issue the guaranteed financial product as an electronic financial product, a physical financial product, or both an electronic financial product and a physical financial product. In some cases, a personal financial product (e.g., a personal check) may be used, at least in part, to initiate a conversions process. In some cases, an enterprise computing system may generate a bar code, QR code, an electronic token, or a certified check. In some cases, the bar code, QR code, and/or electronic token may be used as a verified certification that the personal check may be considered a certified check with payment guaranteed by the enterprise organization. In some cases, scanning the bar code or QR code, or execution of the electronic token, may automatically cause completion of an electronic transaction such as by causing an electronic transfer of funds from an account associated with the enterprise organization to an account associated with the merchant or vendor. In some cases, an image of a certified check or other certified financial product, may be communicated to the merchant or service provider to complete the sale or initiate the service upon printing or depositing a printed version of the image. In some cases, an electronic token may be used to authenticate the personal check as a certified check for the merchant or service provider's electronic transaction records.

In some cases, an illustrative process may start with a user accessing an application, a web page or the like to initiate a process to convert a personal check into a guaranteed financial product that may be recognized by merchants and/or service providers as a bank check (e.g., a certified check). For example, the user may access a user interface screen to enter information online, such as via an application on a mobile device, a web interface or the like. In some cases, an API may be provided to allow for functionality to be integrated with the application or web interface, including a third-party application via a banking as a service API interface. In some cases, telephonic authorization, video conferencing, or similar interfaces may be used to initiate or complete the process.

In some cases, the application programming interface-enabled check generation service may provide an interface that may allow a third-party guaranteed product service, where personal checks from any institution may be electronically certified and/or converted into a guaranteed financial product. In some cases, the application programming interface-enabled check generation service may receive input from a website and/or application, either directly or via an API interface, where a financial institution may provide access to BaaS functionality and/or functions via an API interface, such that the third-party may incorporate the functionality on a website. When the functionality is accessed by a user, the third-party website may pass the entered information to a financial institution computing system, where authentication and/or validation information may be communicated back to the third-party computing system. While many illustrative examples describe consumer-level transactions, the application programming interface-enabled check generation service may provide functionality for institutions to securely complete electronic transactions via a certified electronic transaction interface.

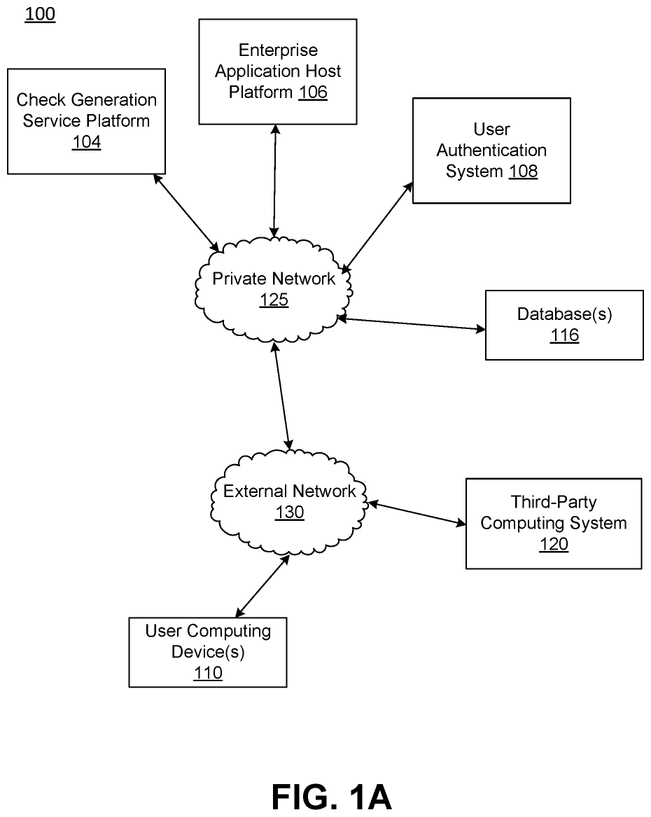

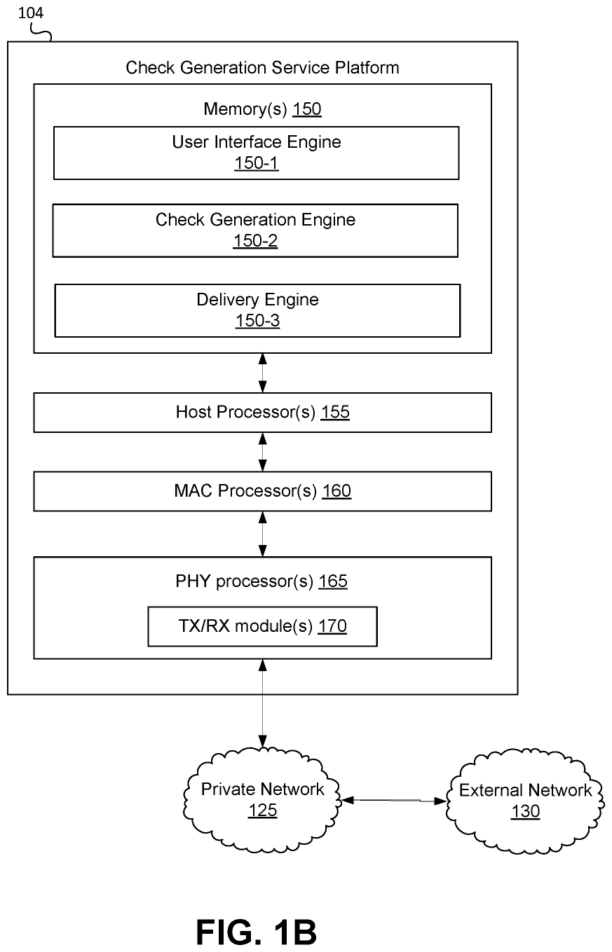

FIG. 1A shows an illustrative computing environment 100 for providing an API-enabled check generation service, in accordance with one or more arrangements. The computing environment 100 may comprise one or more devices (e.g., computer systems, communication devices, and the like). The computing environment 100 may comprise, for example, a check generation service platform platform 104, an enterprise application host platform 106, user authentication system 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a third party computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3^{rd} Generation Partnership Project (3GPP) cellular protocol, a hypertext transfer protocol (HTTP), etc.). While FIG. 1A shows the user authentication system 108 as being associated with the enterprise organization and connected to the private network 125, in other examples, the user authentication system 108 may be separate from the enterprise organization (e.g., may correspond to another financial institution and/or may be a third-party user verification service provider).

The check generation platform 104 may comprise one or more computing devices and/or other computer components (e.g., processors, memories, communication interfaces) configured to perform one or more functions as described herein. Further details associated with the architecture of the check generation platform 104 are described with reference to FIG. 1B.

The enterprise application host platform 106 may comprise one or more computing devices and/or other computer components (e.g., processors, memories, communication interfaces). In addition, the enterprise application host platform 106 may be configured to host, execute, and/or otherwise provide one or more enterprise applications. In an arrangement where the private network 125 is associated with a financial institution (e.g., a bank), the enterprise application host platform 106 may be configured, for example, to host, execute, and/or otherwise provide one or more transaction processing programs, such as an online banking application, fund transfer applications, and/or other programs associated with the financial institution. The enterprise application host platform 106 may comprise various servers and/or databases that store and/or otherwise maintain account information, such as financial account information including account balances, transaction history, account owner information, and/or other information. In addition, the enterprise application host platform 106 may process and/or otherwise execute transactions on specific accounts based on commands and/or other information received from other computer systems comprising the computing environment 100. In some cases, the enterprise application host platform may be configured, for example, to host, execute, and/or otherwise provide one or more transaction processing programs, such as electronic fund transfer applications, online loan processing applications, and/or other programs associated with the financial institution.

The user authentication system 108 may be a host device (e.g., a workstation, a server, and the like) or mobile computing device (e.g., smartphone, tablet). In addition, an administrative computing device may be linked to and/or operated by a specific enterprise user (who may, for example, be an employee or other affiliate of the enterprise organization) who may have administrative privileges to perform various operations within the private network 125. In some cases, the user authentication system may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights. For example, an application may require a passcode or facial recognition for login purposes and may require voice recognition and/or may verify a location of access, a time of day of access and/or may rely on learned patters of activity of the associated user to allow access to a second functionality, such as generation of certified checks.

The third party computing system 120 may comprise one or more computing devices and/or other computer components (e.g., processors, memories, communication interfaces). The third-party computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the third-party computing system 120 is for processing an electronic exchange of goods and/or services. The third-party computing system 120 may be associated with a specific goods purchasing activity, such as purchasing a vehicle, transferring title of real estate may perform communicate with one or more other platforms within the third-party computing system 120.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the compliance verification platform 104. For example, the database(s) 116 may store a listing of accounts that may be potentially associated with compliance issues (e.g., accounts associated with geographical areas that are not serviced by the financial institution, accounts subject to sanctions by a regulatory authority, etc.). In an arrangement, the database(s) 116 may be used for other purposes as described herein.

In one or more arrangements, the check generation service platform 104, the enterprise application host platform 106, the user authentication system 108, the third-party computing system 120, the user devices 110, and/or the other devices/systems in the computing environment 100 may be any type of computing device capable of receiving input via a user interface, and communicating the received input to one or more other computing devices in the computing environment 100. For example, the check generation service platform 104, the enterprise application host platform 106, the user authentication system 108, the third-party computing system 120, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the check generation service platform 104, the enterprise application host platform 106, the user authentication system 108, the third-party computing system 120, the user devices 110, and/or the other devices/systems in the computing environment 100 may, in some instances, be and/or comprise special-purpose computing devices configured to perform specific functions.

FIG. 1B shows an example compliance verification platform 104 in accordance with one or more examples described herein. The compliance verification platform 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The compliance verification platform 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. Memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the compliance verification platform 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 155. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the check generation service platform 104 may be configured to execute machine readable instructions stored in memory 150. The memory 150 may comprise (i) one or more program modules/engines having instructions that when executed by the one or more processors cause the check generation service platform 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the check generation service platform 104 and/or by different computing devices that may form and/or otherwise make up the check generation service platform 104. For example, the memory 150 may have, store, and/or comprise a user interface engine 150-1, a check generation engine 150-2, and/or a delivery engine 150-3. The user interface engine 150-1 may have instructions that direct and/or cause the check generation service platform 104 to perform one or more operations associated with communicating with a user to learn information corresponding to a pending transaction and/or a request for an electronic certified check or other guaranteed financial instrument (e.g., as submitted by an application or web script via an API) are satisfied. The check generation engine 150-2 may have instructions that may cause the check generation service platform 104 to generate an electronic token or other electronic artifact that confirms a physical personal check has been converted to a guaranteed financial instrument, an electronic guaranteed financial instrument, and/or a physical guaranteed financial instrument or certified check. The delivery engine 150-3 may communicate an electronic artifact or guaranteed electronic financial instrument, via one or more networks 125, 130 such as to the third-party computing system 120 and/or the user devices 110.

While FIG. 1A illustrates the check generation service platform 104, the enterprise application host platform 106, and/or the user authentication system 108, as being separate elements connected in the private network 125, in one or more other arrangements, functions of one or more of the above may be integrated in a single device/network of devices. For example, elements in the check generation service platform 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the enterprise application host platform 106, and/or the user authentication system 108.

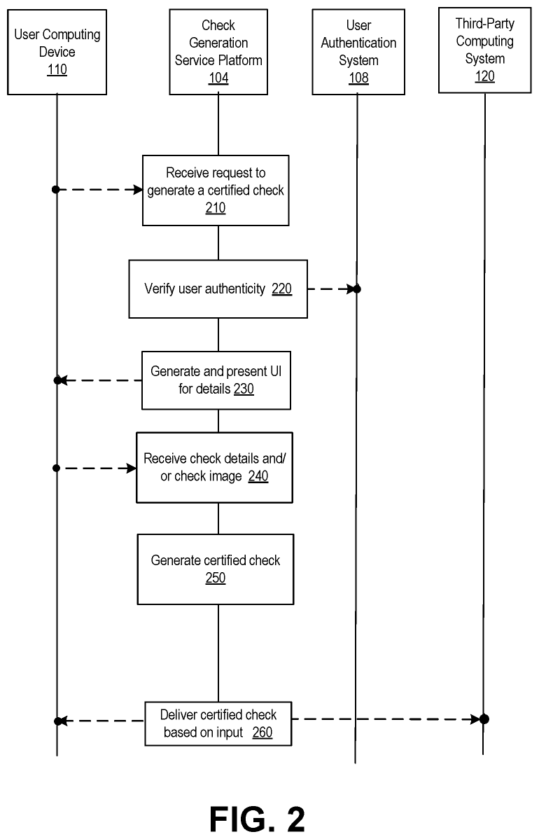

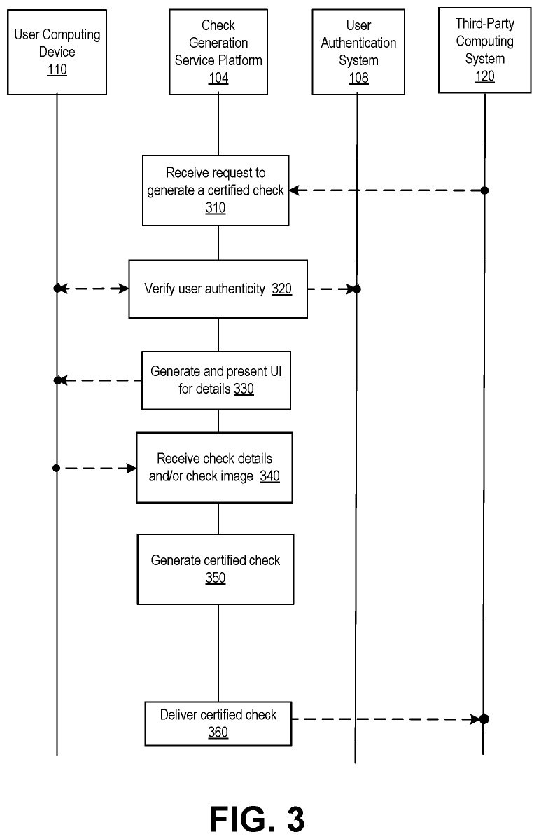

FIGS. 2 and 3 show illustrative event sequences for automatic generation of certified checks, in accordance with one or more illustrative arrangements. The user computing device 110 may be used to initiate (e.g., submit, request) generation of a guaranteed financial instrument via an application (e.g., a mobile application, a web interface and the like). In some cases, the request for a certified check may be initiated in preparation of or in a process of a transaction for a product or service. For example, the transaction may correspond to a purchase involving a substantial amount of money for a vehicle, real estate, or the like. FIG. 2 shows an illustrative request for conversion of a personal financial instrument, a personal check, into a guaranteed financial instrument, such as a certified check. At 210, A user of the user device 110 may initiate a conversion process via a mobile application, where the check generation service platform 104 may cause display of a user interface on the mobile device 110 to present a form to request input of information to be used when generating the guaranteed financial instrument. For example, the user interface may include fields for entry of a merchant name, a monetary amount, a personal check number, and optionally a delivery method for the guaranteed financial product when generated and/or a means of uploading an image of the personal check. In some cases, the request to initiate the generation of a certified check may comprise an upload of an image of a personal check, an access of a user interface screen to enter request information, and/or a selection of an input to request access to the user interface screen.

At 220, the check generation service platform 104 may verify an identity of the user requesting conversion of the personal check to a guaranteed financial instrument and/or generation of a guaranteed financial instrument. In some cases, the check generation service platform 104 may initiate a user validation procedure by the user authentication system 108 after the user logs into an application and/or accesses a user interface to request the generation of the guaranteed financial instrument. For example, a user may log into an application, such as a mobile application installed on a user device, where to access protected information accessed by the application, the user authentication system 108 must return confirmation of the user identity and validation of the provided user validation information. The user authentication system 108 may request and/or receive user password/passcode information, user biometric information, user facial recognition information, user image information, user voice recording information, user location information, user historical activity information and/or the like. In some cases the user authentication system 108 may perform second and/or third user validity requests, such as when a user is accessing the application at an unusual time (e.g., after midnight), at a new or suspect location, and/or after or during an unusual activity pattern, where the unusual information corresponds to differences from historical time, location and/or activity patterns.

At 230, the check generation service platform 104 upon successful user validation, may generate the user interface that allows the user of the user computing device 110 to enter information corresponding to the request to convert the personal check to the guaranteed financial instrument and/or generation of a new guaranteed financial instrument. In some cases, at least a portion of the user interface may be provided at a same time that the request to generate the guaranteed financial instrument is received, such as at 210. Information requested may include an image of a completed personal check written to the recipient of the guaranteed financial instrument, a blank personal check, user information such as address information or other contact information, a funds amount, account information, and/or the like. In some cases, at least a portion of the information may be identified from a scanned personal check. Additional information entered via the user interface caused to be presented on the user computing device by the check generation service platform 104, may include an input identifying a delivery type and/or format for the guaranteed financial instrument as needed for the third-party computing system 120. For example, the user may select electronic delivery via one or more electronic delivery methods such as via a telecommunication network message (e.g., a text message), via email, and/or the like. In some cases, the user may select physical delivery of a physical guaranteed financial instrument, such as a certified check, to a mailing address of the corresponding merchant or service provider. In some cases, the delivery input may include both a request for electronic delivery and physical delivery. In some cases, the user authentication system may further be configured to validate an identity of the recipient of the guaranteed financial instrument, such as by communicating a confirmation request to the third-party computing system 120, analyzing the recipient information identification information and comparing against a list of suspected or known fraudulent identities and/or compare the recipient third party computing system information (e.g., location information, network information, network address information, and the like) to lists of suspected or known fraudulent computing device information. The user authentication system 108 may advantageously offload various authentication and compliance verification tasks, associated with a transaction, from an end user, the application, and/or an external verification service provider.

At 240, the user of the user computing device 110 may upload an image of the personal check and/or complete entry of details for the guaranteed financial instrument. The user computing device 110 may electronically communicate the information to the check generation service platform 104 via a network, such as a telecommunications network, the internet, a wide area network, local area network, a WIFI network and/or the like.

At 250, the check generation service platform 104 may generate a guaranteed financial instrument, e.g., a certified check, based on the information received from the user computing device. For example, the check generation service platform 104 may verify that a requested funds amount is available in an associated user account. If not, the check generation service platform 104 may end the process and/or may communicate a request to the user computing device 110 for alternate funding sources. Once the funds amount has been verified, the check generation service platform may verify authenticity of the personal check image and/or information, such as by comparing an image or entered information, against historical personal check images and/or information. In some cases, when an executed personal check image has been uploaded, handwriting and/or signature analysis may be performed to verify authenticity of the personal check image.

Once the personal check information has been entered, user validity information and/or (optionally) third-party validity information has been validated, the check generation service platform 104 may generate a certified financial instrument and/or an indication that the personal check has been converted into a certified financial instrument. For example, the check generation service platform may generate a bar code, a QR code and/or an electronic token that, when scanned or executed by a computing device associated with the third-party computing system 120, may recognize a provided personal check as a guaranteed financial product having payment guaranteed by the backing financial institution. In some cases, the bar code QR code and/or electronic token may be electronically delivered in one or more formats such as a text message, an email message, an instant messenger message, or other format capable of being received by the third-party computing system 120. In some cases, an image of the personal check may be modified by the check generation service platform 104 to format the guaranteed financial product for identification as, for example, a certified check. In some cases, the formatting may include adding the bar code or QR code to the personal check, adding additional guaranty information, such as a guaranteed account number from which the funds are to be drawn. In some cases, the electronic token may be associated with a file returned to the user, or may be sent as a stand-alone electronic object. In some cases, a new image of a guaranteed financial instrument may be generated and communicated for printing, and/or deposit through the third-party computing system 120 as would normally occur for a standard certified check provided by a bank or other financial institution. In some cases, the generated image may include the bar code, the QR code, and/or an image of the personal check included in the image of the guaranteed financial instrument. In some cases, the guaranteed financial instrument may comprise an electronic notification with a link to complete the transaction with guaranteed payment by the financial instruction, when the link is followed by the recipient and/or automatically by the third-party computing system 120.

At 260, the guaranteed financial product may be delivered in an electronic form via a messaging or communications network. In some cases, delivery of a physical guaranteed financial product may be delivered in addition to, or instead of, the electronic delivery. In some cases, if configured by the third-party computing system, delivery of the guaranteed financial product may include deposit of an amount of funds into an account associated with the third-party computing system 120.

Turning to FIG. 3, at 310, an API interface may be incorporated into a third-party application or web service provided by the third-party computing system and may be accessed and/or called in response to inputs presented to a user. In some cases, these user inputs may be presented via a web service, a mobile application, and/or other software packages where the user inputs provided by the third-party computing system 130 may be displayed by and receive input from the user device 110, such as via a network connection (e.g., an internet connection, a wide area network connection, and the like). For example, the user interface may include fields for entry of a merchant name, a monetary amount, a personal check number, and optionally a delivery method for the guaranteed financial product when generated and/or a means of uploading an image of the personal check. In some cases, the request to initiate the generation of a certified check may comprise an upload of an image of a personal check, an access of a user interface screen to enter request information, and/or a selection of an input to request access to the user interface screen. In some cases, third-party information may be self-filled by a process operating on the third-party computing system 120.

At 320, user authenticity may be performed via an initiation received from an API call from the third-party computing system 120. In response to that function call, the check generation service platform 104 may initiate a user authentication process by sending a request for user input to the user computing device via a network connection. In some cases, the requested information may include user identification information, user residence information, user passcode information, user biometric information, user voice information, and/or the like. The user authentication system may validate or invalidate authenticity of the user information and provide feedback to the check generation service platform 104. Upon a user invalidity notification, an API function return may be made to the third-party computing system 120 notifying the calling application of the error and ending the process. Generation of a user interface and presenting of the user interface by user device 110 at 330, receiving details of a requested personal financial instrument information and/or a check image at 340, generation of the guaranteed financial product, such as a certified check, at 350 and delivery of the guaranteed financial product at 360 may operate similarly as described above with respect to FIG. 2 above.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a user computing device comprising:
a display presenting a user interface screen comprising an input that triggers a process for generation of an electronic guaranteed financial product and an input to generate an image capture command; and
a processor processing instructions to capture an image of a physical personal financial product in response to the image capture command;
a financial product generation service platform communicatively coupled to the user computing device, comprising:
at least one processor; and
memory storing computer-readable instructions that, when executed by the at least one processor, cause the financial product generation service platform to:
receive, via a network, the image of the physical personal financial product;
receive, via an input and from the user computing device via a network, a request to generate a guaranteed financial product based on the image of the physical personal financial product;
cause display, at the user computing device, of a user interface screen requesting inputs corresponding to the personal financial product and account information associated with the personal financial product;
generate, based on verification of the account information, an electronic object corresponding to a generated guaranteed financial product;
generate the guaranteed financial product by incorporating the electronic object into the image of the physical personal financial product; and
deliver, via the network, the guaranteed financial product to a third-party computing system.

2. (canceled)

3. The system of claim 12, wherein the personal financial product comprises a personal check.

4. The system of claim 12, wherein the personal financial product is scanned by the user computing device.

5. The system of claim 1, wherein the instructions cause the financial product generation service platform to generate the electronic object as one of a bar code or a quick response (QR) code.

6. The system of claim 1, wherein the instructions cause the financial product generation service platform to generate the electronic object as an electronic token.

7. The system of claim 1, wherein the instructions cause the financial product generation service platform to: initiate execution, automatically by the third-party computing system and based on validation of the electronic object, of the guaranteed financial product.

8. The system of claim 7, wherein the electronic guaranteed financial product comprises an image of a scanned personal check.

9. The system of claim 1, wherein the instructions cause the financial product generation service platform to:
generate a physical representation of the electronic guaranteed financial product. comprising a certified check; and
cause delivery, via a delivery method, of the certified check to a recipient.

10. A method comprising:
receiving, via an input and from a user device via a network, a request to generate a guaranteed financial product;
causing display, at the user device, of a user interface screen requesting inputs corresponding to a personal financial product and account information associated with the personal financial product;
capturing, by the user device based on the request to generate a guaranteed financial product, an image of the personal financial product;
generating, based on verification of the account information, an electronic object corresponding to a generated guaranteed financial product;
generating the guaranteed financial product by combining the electronic object with the image of the personal financial product;
delivering, via the network, the guaranteed financial product to a third-party computing system; and
executing, automatically by the third-party computing system, execution of the guaranteed financial product based on validation of the electronic object.

11. The method of claim 10, comprising receiving, from the user device, an image of the personal financial product.

12. The method of claim 10, comprising receiving, from a third-party computing system via an application programming interface (API), an image of the personal financial product.

13. The method of claim 11, wherein the personal financial product comprises a personal check.

14. The method of claim 11, wherein the personal financial product is scanned by the user device.

15. The method of claim 10, further comprising generating the electronic object as one of a bar code or a quick response (QR) code.

16. The method of claim 10, further comprising generating the electronic object as an electronic token.

17. The method of claim 10, further comprising generating an image comprising an electronic guaranteed financial product.

18. The method of claim 17, wherein the electronic guaranteed financial product comprises an image of a scanned personal check.

19. The method of claim 10, further comprising:
generating a physical representation of the guaranteed financial product. comprising a certified check; and
causing delivery, via a delivery method, of the certified check to a recipient.

20. Non-transitory computer readable media storing instructions that, when executed by a processor, cause a computing device to:
receive, via a network, an image of a physical personal financial product;
receive, via an input and from a user computing device via a network, a request to generate a guaranteed financial product;
cause display, at the user computing device, of a user interface screen requesting inputs corresponding to a personal financial product and account information associated with the personal financial product based on the image of the physical personal financial product;
generate, based on verification of the account information, an electronic object corresponding to a generated guaranteed financial product and comprising a guaranteed account identifier that identifies the guaranteed account from which funds are to be drawn;
generate the guaranteed financial product by incorporating the electronic object into the image of the physical personal financial product; and
deliver, via the network, the guaranteed financial product to a third-party computing system; and
initiate, by the third-party computing system and based on validation of the electronic object, automatic execution of the guaranteed financial product.
